(19) United States
(12) Patent Application Publication
(10) Pub. No.: US 2026/0010109 A1
(43) Pub. Date: Jan. 8, 2026

(54) PRINT SYSTEM, METHOD OF CONTROLLING PRINT SYSTEM PERFORMING STATIC ELECTRICITY ELIMINATION PROCESSING, AND STORAGE MEDIUM

(71) Applicant: CANON KABUSHIKI KAISHA, Tokyo (JP)

(72) Inventor: NORITSUGU OKAYAMA, Tokyo (JP)

(21) Appl. No.: 19/253,513

(22) Filed: Jun. 27, 2025

(30) Foreign Application Priority Data
Jul. 5, 2024 (JP) 2024-108790

(51) Int. Cl. G03G 15/00

(52) U.S. Cl. CPC G03G 15/6573; G03G 15/5016

(57) ABSTRACT

A print system including a print apparatus for printing an image on a sheet and a static electricity elimination apparatus for performing static electricity elimination processing from a direction above the sheet is provided. The print system further includes a processor that, by execution of a program, operates as a first acceptance unit configured to accept a setting regarding whether to perform the static electricity elimination processing on the sheet, a second acceptance unit configured to accept a setting regarding whether to place the sheet with its print side face-up or face-down when the sheet is discharged from the static electricity elimination apparatus, and a notification unit configured to output a predetermined notification when the first acceptance unit has accepted a setting to perform the static electricity elimination processing on the sheet and the second acceptance unit has accepted a setting to place the sheet with its print side face-down.

### BACKGROUND

### Field of the Technology

The present disclosure relates to a print system, a method of controlling the print system, and a storage medium.

### Description of the Related Art

A storage medium (hereinafter representatively referred to as a “sheet”) used in a print operation is conveyed in a state where the storage medium is statically charged due to residual charges generated during an electrophotographic process or due to slight friction with a conveyance roller or a guide occurring during conveyance of the sheet. Due to this static electricity, sheets may sometimes stick to each other. Adherence of dust or paper fine particles to a deliverable causes a deterioration in the quality of the deliverable.

Plain paper or the like by itself exhibits low electrical resistance, and charge transfer within such a sheet therefore easily occurs. Thus, plain paper has a small electric charge amount, and static charges are quickly eliminated. However, a sheet made of a synthetic resin (plastic), such as thick paper, synthetic paper, or coated paper, by itself exhibits high electrical resistance, and charge transfer within the sheet hardly occurs. As a result, there is a tendency that a sheet such as one made of synthetic paper or coated paper is more easily statically charged, and that more residual charges remain on the sheet. It is generally known that a sheet is susceptible to the influence of an environment, especially the influence of humidity, and is more statically charged in a lower humidity environment due to a decreased amount of discharge into the air. Post-processing performed in a state where sheets stick to each other may affect sheet alignment processing, which would not only significantly deteriorate the quality of the post-processing, but also possibly trigger a jam due to a sheet feeding defect or a sheet conveying defect at the time of the post-processing.

For this reason, to avoid such a risk, it is desirable that static electricity on the sheet having been printed be eliminated before execution of the post-processing. To address this issue, proposed is a print apparatus that performs so-called static elimination processing by applying a voltage to a conveyance roller located on a downstream side in a sheet conveyance direction to negate static charges on the sheet (refer to Japanese Patent Application Laid-Open No. H11-258881).

The static elimination implemented by a configuration in which a voltage is applied to the conveyance roller (hereinafter referred to as a “static elimination roller”) applies, via the static elimination roller, charges to a sheet that are opposite of the static charges on the sheet to negate static electricity. According to Japanese Patent Application Laid-Open No. H11-258881, static elimination is implemented by a method of applying to a conveyed sheet whose print side is an upper side (hereinafter referred to as “face-up”), opposite charges of static charges on the sheet via the roller.

Because one side of the sheet to which toner is transferred and on which printing is performed becomes noticeably charged, the pint apparatus in Japanese Patent Application Laid-Open No. H11-258881 is configured to, at the time of static elimination, convey the sheet face-up in accordance with the polarity of the static elimination roller to eliminate static charges. Hence, to appropriately eliminate static charges, it is necessary to convey the sheet so that the print side of the sheet is placed face-up in accordance with the polarity of the static elimination roller. However, if a user unconsciously sets the print apparatus to perform printing on a lower side of the sheet (hereinafter referred to as “face-down”), the user cannot obtain a print product with quality as expected by the user.

### SUMMARY

According to an aspect of the present disclosure, a print system includes a print apparatus configured to print an image on a sheet, a static electricity elimination apparatus configured to perform static electricity elimination processing from a direction above the sheet, at least one memory storing a program, and at least one processor that, by execution of the stored program, is configured to operate as: a first acceptance unit configured to accept a first setting regarding whether to perform the static electricity elimination processing on the sheet, a second acceptance unit configured to accept a second setting regarding whether to place the sheet with its print side face-up or face-down when the sheet is discharged from the static electricity elimination apparatus, and a notification unit configured to output a predetermined notification when the first acceptance unit has accepted a first setting to perform the static electricity elimination processing on the sheet and the second acceptance unit has accepted a second setting to place the sheet with its print side face-down.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a system configuration according to an exemplary embodiment.

FIG. 2 is a hardware block diagram of a print apparatus according to the exemplary embodiment.

FIG. 3 is a diagram illustrating a cross-sectional view of a print system according to the exemplary embodiment.

FIG. 4 is a diagram illustrating an operation unit included in the print apparatus according to the exemplary embodiment.

FIG. 5 is a hardware block diagram of a static elimination apparatus according to the exemplary embodiment.

FIG. 6 is a diagram illustrating an example of a display screen for a static elimination setting to be displayed on the operation unit according to the exemplary embodiment.

FIG. 7 is a schematic diagram illustrating apparatuses that perform processing from printing of an image to static elimination processing according to the exemplary embodiment.

FIG. 8 is a flowchart illustrating printer setting processing according to the exemplary embodiment.

FIG. 9 is a diagram illustrating an example of a display screen for a sheet discharge side setting to be displayed on the operation unit according to the exemplary embodiment.

FIG. 10 is a diagram illustrating an example of a display screen for a warning against printer settings to be displayed on the operation unit according to the exemplary embodiment.

FIG. 11 is a flowchart illustrating processing of executing a print job according to a second exemplary embodiment.

FIG. 12 is a diagram illustrating an example of a display screen for a warning against printer settings to be displayed on the operation unit according to the second exemplary embodiment.

FIG. 13 is a flowchart illustrating printer setting processing according to a third exemplary embodiment.

FIG. 14 is a flowchart illustrating processing of executing a print job according to the third exemplary embodiment.

### DESCRIPTION OF THE EMBODIMENTS

Exemplary embodiments for implementing the present disclosure will be described in detail with reference to drawings. However, constituent elements described in the exemplary embodiments are merely examples and are not intended to limit the scope of the present disclosure.

The exemplary embodiments for implementing the present disclosure are now described with reference to the drawings.

### Overall Configuration of System

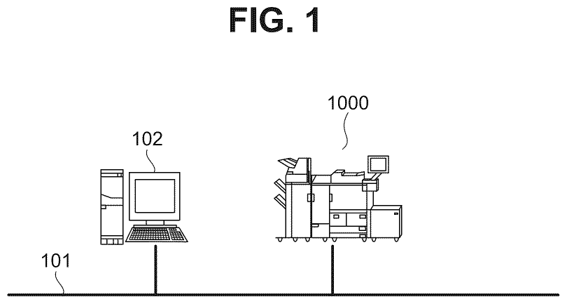

FIG. 1 illustrates a configuration of a first exemplary embodiment. The configuration includes a print system 1000 and a client computer 102 (hereinafter referred to as a “PC 102”), which are connected to each other via a network 101. The PC 102 is capable of transmitting code data in a page description language (PDL), which is a print job, to the print system 1000 via the network 101. In FIG. 1, the network 101 is a wired network, but may be a wireless network.

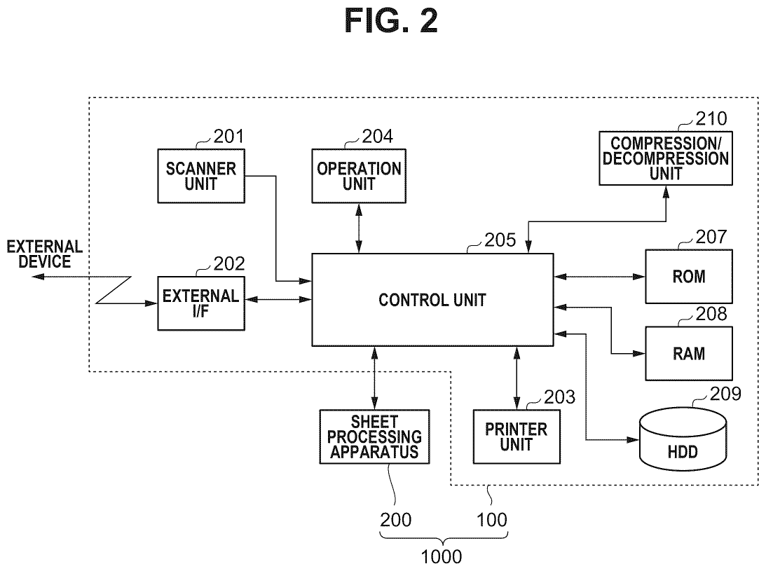

The print system 1000 is now described with reference to the system block diagram of FIG. 2. The print system 1000 includes a print apparatus 100, which is a portion surrounded by a dotted line in FIG. 2, and a sheet processing apparatus 200. A freely selected number of sheet processing apparatuses 200 can be connected to the print apparatus 100. In the present exemplary embodiment, a multi-function peripheral (MFP) having a plurality of functions, such as a copy function or a printer function, is an example of the print apparatus 100. However, the print apparatus 100 may be a single function print apparatus having only the copy function or the printer function. In the present exemplary embodiment, for example, assume that the print system 1000 satisfies the following various configuration requirements.

The print system 1000 has a configuration that allows the sheet processing apparatus 200 connected to the print apparatus 100 to execute sheet processing on a sheet printed by the print apparatus 100. Alternatively, the print system 1000 may include only the print apparatus 100 to which the sheet processing apparatus 200 is not connected.

The sheet processing apparatus 200 is configured to be capable of communicating with the print apparatus 100. When receiving an instruction from the print apparatus 100, the sheet processing apparatus 200 is capable of executing sheet processing as described below.

A scanner unit 201 reads an image on a document, converts the image into image data, and transfers the image data to another unit.

An external interface (I/F) 202 transmits/receives data to/from another apparatus connected to the network 101.

A printer unit 203 prints an image based on input image data onto a sheet.

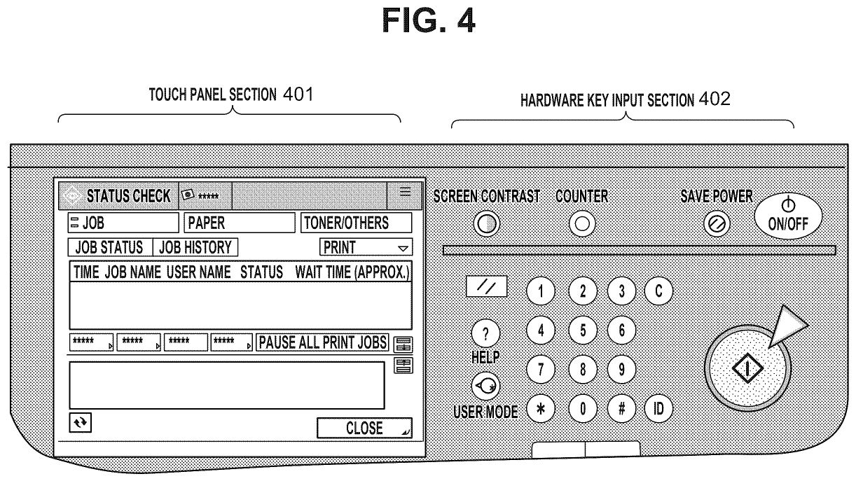

An operation unit 204 has a configuration as illustrated in FIG. 4 and includes a hardware key input section 402 and a touch panel section 401. The operation unit 204 accepts instructions from a user via these sections. Various kinds of printer settings to be used in print control can be made using the operation unit 204. For example, it is possible to make various kinds of printer settings including a static elimination setting (a static electricity elimination setting) at the time of printing and a sheet discharge side setting in which it is possible to select whether to place the print side of the sheet face-up or face-down at the time of sheet discharge. The operation unit 204 performs various kinds of display on the touch panel section 401 included in the operation unit 204.

A control unit 205 is a central processing unit (CPU) that performs integrated control of processing, operations, or the like in various kinds of units included in the print system 1000. That is, the control unit 205 controls operation of the print apparatus 100 and operation of the sheet processing apparatus 200 connected to the print apparatus 100.

A read-only memory (ROM) 207 stores various kinds of computer programs to be executed by the control unit 205.

For example, the ROM 207 stores therein a program for causing the control unit 205 to execute various kinds of processing, as illustrated in the flowcharts, and a display control program necessary for displaying various kinds of setting screens. The flowcharts and the various kinds of setting screens will be described below. The ROM 207 stores therein a program for causing the control unit 205 to execute an operation of interpreting PDL code data received from the PC 102 and expanding the PDL data into raster image data. In addition, the ROM 207 stores therein a boot sequence, font information, and a threshold for determination about a static elimination effect (a static electricity elimination effect), which will be described below.

A random-access memory (RAM) 208 stores therein image data and code data transmitted from the scanner unit 201 or the external I/F 202, various kinds of programs loaded from the ROM 207, and setting information. The RAM 208 stores therein information regarding the sheet processing apparatus 200 (information regarding a type and function of each sheet processing apparatus 200 connected to the print apparatus 100 and other information). The control unit 205 is capable of using these pieces of information regarding the sheet processing apparatus 200 stored in the RAM 208 for control.

A hard disk drive (HDD) 209 is composed of a hard disk, a drive unit that reads/writes data from/to the hard disk, and the like. The HDD 209 is a high-capacity storage device to store image data that is input from the scanner unit 201 and that is compressed by a compression/decompression unit 210.

The control unit 205 is capable of printing the image data stored in the HDD 209 using the printer unit 203 based on an instruction from the user. The HDD 209 is also used as a spooler, and the control unit 205 is capable of managing the PDL code data received from the PC 102 as a print job and storing the PDL code data in the HDD 209.

The control unit 205 is capable of managing print jobs stored in the HDD 209 and acquiring the number of stored print jobs and setting information set in the print jobs.

The compression/decompression unit 210 performs a compression/decompression operation on image data or the like stored in the RAM 208 or the HDD 209 by various kinds of compression schemes such as a Joint Bi-level Image Experts Group (JBIG) scheme or a Joint Photographic Experts Group (JPEG) scheme.

### Hardware Configuration of Print System

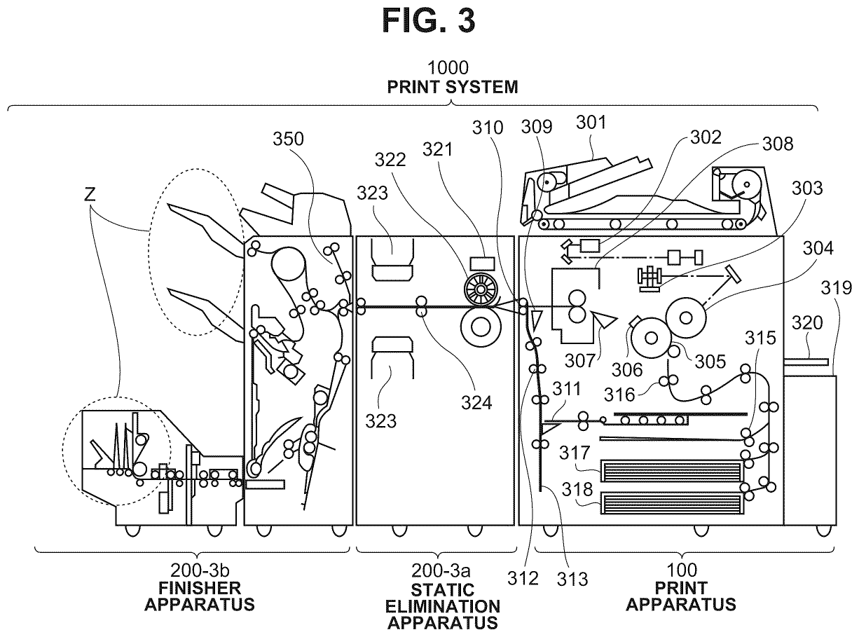

A configuration of the print system 1000 is described with reference to FIG. 3. FIG. 3 is a diagram illustrating a cross-sectional view of the print apparatus 100 and the sheet processing apparatus 200 connected to the print apparatus 100. In FIG. 3, the sheet processing apparatus 200 is configured to include a static elimination apparatus (a static electricity elimination apparatus) 200-3a and a finisher apparatus 200-3b.

### (Print Apparatus)

The print apparatus 100 is now described.

An automatic document feeder (ADF) 301 sequentially separates a document bundle set on a placement surface of a document tray from the first page of the document bundle in the order of pages and conveys each page of the document bundle onto a platen glass for scanning by a scanner 302.

The scanner 302 reads an image of each page of the document bundle conveyed onto the platen glass and converts the image into image data with a charge-coupled device (CCD).

A rotary polygon mirror (polygon mirror or the like) 303 receives a light beam, such as laser light, which is modulated according to the image data, and irradiates a photosensitive drum 304 with the light beam as reflection scan light beam via a reflection mirror. A latent image formed by the laser light on the photosensitive drum 304 is developed with toner, and a toner image is transferred to a sheet that is adhering to a transfer drum 305. This series of image forming processes is sequentially executed with respect to yellow (Y), magenta (M), cyan (C), and black (K) toners, whereby a full color image is formed. After the image forming process is executed four times, the sheet, on which the full color image is formed, is separated from the transfer drum 305 by a separation pawl 306 and conveyed to a fixing device 308 by a pre-fixing conveyance device 307.

The fixing device 308 includes a combination of rollers and a belt, and a heat source such as a halogen heater is built into the fixing device 308. The fixing device 308 dissolves toner on the sheet onto which the toner image is transferred with heat and pressure and fixes the toner image.

A discharge flapper 309 is configured to be pivotable about a pivot axis and defines a sheet conveyance direction. When the discharge flapper 309 pivots in a clockwise direction in FIG. 3, the sheet is conveyed straight and discharged to the outside of the print apparatus 100 by sheet discharge rollers 310. The control unit 205 controls the print apparatus 100 in the above-mentioned sequence so as to execute one-sided printing.

On the other hand, in a case where images are formed on both sides of the sheet, the discharge flapper 309 pivots in a counterclockwise direction in FIG. 3, and the traveling direction of the sheet is changed to a lower direction, and the sheet is sent to a double-sided conveyance unit. The double-sided conveyance unit includes an inversion flapper 311, inversion rollers 312, an inversion guide 313, and a double-sided tray 314.

The inversion flapper 311 pivots about a pivot axis and defines the sheet conveyance direction. In a case of processing a double-sided print job, the control unit 205 controls the printer unit 203 to cause the inversion flapper 311 to pivot in the counterclockwise direction in FIG. 3 and send the sheet whose first side has been printed by the printer unit 203 to the inversion guide 313 via the inversion rollers 312. The control unit 205 then temporarily stops the inversion rollers 312 in a state where a trailing end of the sheet is nipped by the inversion rollers 312 and subsequently causes the inversion flapper 311 to pivot in the clockwise direction in FIG. 3. Simultaneously, the control unit 205 rotates the inversion rollers 312 in the opposite direction.

With this operation, the control unit 205 performs control to turn around and convey the sheet, guiding it to the double-sided tray 314 in a state where the trailing end of the sheet and the leading end of the sheet are switched with each other. The sheet is temporarily stacked on the double-sided tray 314 and thereafter conveyed to registration rollers 316 by re-feed rollers 315. At this time, the sheet is conveyed so that the side opposite the first side in the transfer process faces the photosensitive drum 304. A second image is formed on the second side of the sheet in a manner similar to the above-mentioned process. Respective images are thereby formed on both sides of the sheet, and the sheet is subjected to a fixing process and discharged from the inside of the main body of the print apparatus 100 to the outside of the print apparatus 100 via sheet discharge rollers 310. The control unit 205 controls the print apparatus 100 in the above-mentioned sequence so as to execute double-sided printing.

The print apparatus 100 includes a sheet feed unit that stores sheets necessary for print processing. Examples of the sheet feed unit include sheet feed cassettes 317 and 318 (each capable of storing, for example, 500 sheets), a sheet feed deck 319 (capable of storing, for example, 5000 sheets), a manual feed tray 320, and the like. Various kinds of sheets having different sizes and materials can be separately set in the sheet feed cassettes 317 and 318 and the sheet feed deck 319 on a sheet feed unit-by-sheet feed unit basis. Various kinds of sheets including a special sheet, such as an overhead projector (OHP) sheet, can be set in the manual feed tray 320. As for sheet type information regarding various sheets set in the respective sheet feed units in the print apparatus 100, it is possible to cause the control unit 205 to register and store sheet type information regarding each sheet feed unit from the operation unit 204. Hence, the control unit 205 is configured to be capable of determining the above-mentioned registered sheet type information and what type of sheet is currently subjected to print processing while the print apparatus 100 is producing print output.

### (Static Elimination Apparatus)

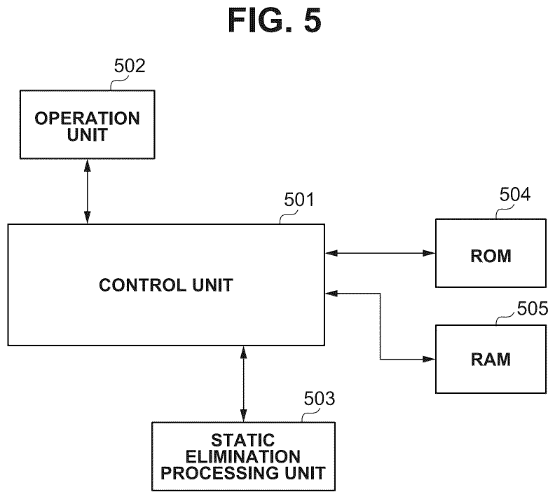

The static elimination apparatus 200-3a is now described. FIG. 5 is a system block diagram of the static elimination apparatus 200-3a. The static elimination apparatus 200-3a also includes a control unit 501 separate from the control unit 205 of the print apparatus 100. The control unit 501 integrally manages the whole of the static elimination apparatus 200-3a while communicating with the control unit 205 of the print apparatus 100 illustrated in FIG. 2 via a bus, which is not illustrated.

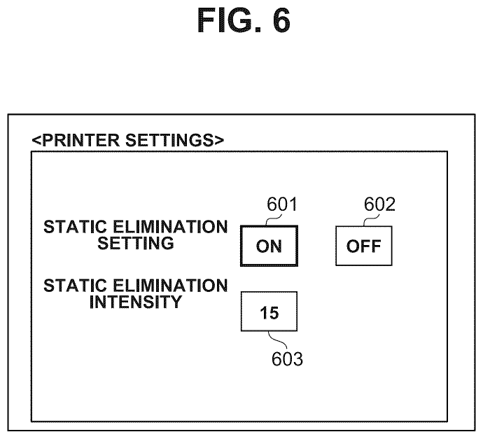

FIG. 6 illustrates an example of a printer setting screen of the static elimination apparatus 200-3a to be displayed on the operation unit 204. It is possible to accept the user's printer settings regarding the static elimination apparatus 200-3a via the touch panel section 401 and the hardware key input section 402.

An “ON” button 601 and an “OFF” button 602 illustrated in FIG. 6 are used to switch whether the static elimination apparatus 200-3a performs static elimination (static electricity elimination) (ON/OFF), and the control unit 501 adjusts the intensity of static elimination control according to a numeric value entered in a “STATIC ELIMINATION INTENSITY” field 603.

A static elimination processing unit 503 is composed of a static elimination roller 322, an ionizer 323, and a voltage application controller 321 that applies a voltage to each of the static elimination roller 322 and the ionizer 323. The static elimination processing unit 503 performs static elimination processing on a conveyed sheet. The control unit 501 implements control of applying a voltage to each of the static elimination roller 322 and the ionizer 323 via the voltage application controller 321.

A boot program for the static elimination apparatus 200-3a, a control program for an operation unit 502, a static elimination processing program for the static elimination processing unit 503, and the like are stored in a ROM 504. The control unit 501 loads a necessary program from the ROM 504 into a RAM 505 as appropriate and executes the program.

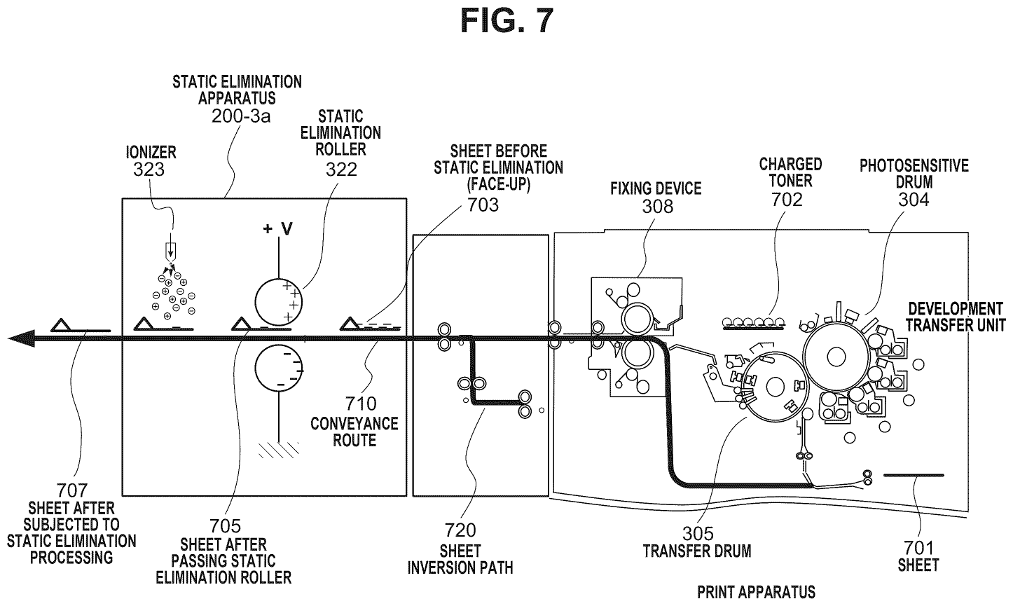

FIG. 7 is a schematic diagram illustrating how the static elimination apparatus 200-3a executes the static elimination processing on a sheet that has been subjected to print processing by the print apparatus 100.

A sheet 701 is conveyed to a development transfer unit composed of the photosensitive drum 304 and the transfer drum 305 via a conveyance route 710, and toner is placed on the sheet 701.

Charged toner 702 placed on the sheet 701 is negatively charged. Subsequently, in a case where face-up is set in the sheet discharge side setting in the printer settings, a sheet 703 that has passed the fixing device 308 and been subjected to fixing, but has yet to be subjected to static elimination, is conveyed to the static elimination apparatus 200-3a in a state where the upper side as the print side is negatively charged. In a case where face-down is set in the sheet discharge side setting, the sheet 703 that has passed the fixing device 308 is guided to a sheet inversion path 720 and turned around.

With this operation, the print side is placed face-down, and the sheet 703 is conveyed to the static elimination apparatus 200-3a in a state where the lower side as the print side is negatively charged in an opposite manner to a case where the print side is placed face-up. In a case where an attempt is made to cause the static elimination apparatus 200-3a to perform static elimination with the print side being placed face-down, there is a possibility that static elimination is not properly performed and charging on the sheet deteriorates. The sheet discharge side setting will be described below.

The static elimination apparatus 200-3a includes the static elimination roller 322, which is positively charged. The static elimination apparatus 200-3a performs contact static elimination using the static elimination roller 322 and applies positive charges to the sheet 703 whose print side is negatively charged to eliminate a charged state. However, it is assumed that negative charges, which cannot be completely eliminated by the static elimination processing with the static elimination roller 322, or oppositely charged, positive charges remain on a sheet 705 that has passed the static elimination roller 322.

Furthermore, the static elimination apparatus 200-3a described in the present exemplary embodiment is configured to include the ionizer 323 on the downstream side of the static elimination roller 322.

The ionizer 323 is a device that applies a voltage to an electrode needle included in the ionizer 323 to cause corona discharge and eliminate static charges using ions generated by the corona discharge.

In this manner, static charges are roughly eliminated by the static elimination roller 322, and residual charges are removed by the ionizer 323, whereby a sheet 707 that is discharged from the static elimination apparatus 200-3a after being subjected to the static elimination processing is in a state in which static charges are eliminated.

Going back to the description with reference to the cross-sectional view in FIG. 3, the static elimination apparatus 200-3a includes the static elimination roller 322 and its paired roller, and the sheet conveyed to the static elimination apparatus 200-3a is conveyed while being nipped by the static elimination roller 322 and the paired roller and subjected to the above-mentioned rough static elimination with the static elimination roller 322. Thereafter, the sheet is subjected to the static elimination processing of eliminating residual charges by the ionizer 323 while being conveyed by conveyance rollers 324 to the outside of the static elimination apparatus 200-3a.

### (Finisher Apparatus)

The finisher apparatus 200-3b is now described. Examples of the sheet processing performed by the finisher apparatus 200-3b include saddle stitch bookbinding, punching processing, cutting processing, shifted sheet discharge processing, folding processing, staple processing, and the like. These jobs are each referred to as a “saddle stitch bookbinding job”.

In a case of processing the saddle stitch bookbinding job, the control unit 205 causes the static elimination apparatus 200-3a to convey the sheet that has been printed by the print apparatus 100 to the finisher apparatus 200-3b on the downstream side, and thereafter causes the finisher apparatus 200-3b to execute the sheet processing of the job. The control unit 205 then causes a sheet discharge destination Z of the finisher apparatus 200-3b to retain a print product of the saddle stitch bookbinding job subjected to the sheet processing performed by the finisher apparatus 200-3b.

A sheet discharge inversion path 350 draws in and turns around the sheet output from the static elimination apparatus 200-3a, and can thereby change whether to place the print side of the sheet to be discharged to the sheet discharge destination Z face-up or face-down.

There is a plurality of candidates for the sheet discharge destination Z. This is because the finisher apparatus 200-3b is capable of executing a plurality of types of sheet processing, and the candidates are used when sheets are separately discharged to different destinations depending on sheet processing. In the present exemplary embodiment, a description about a detailed procedure for conveying the saddle stitch bookbinding job is omitted.

### [Printer Setting Processing]

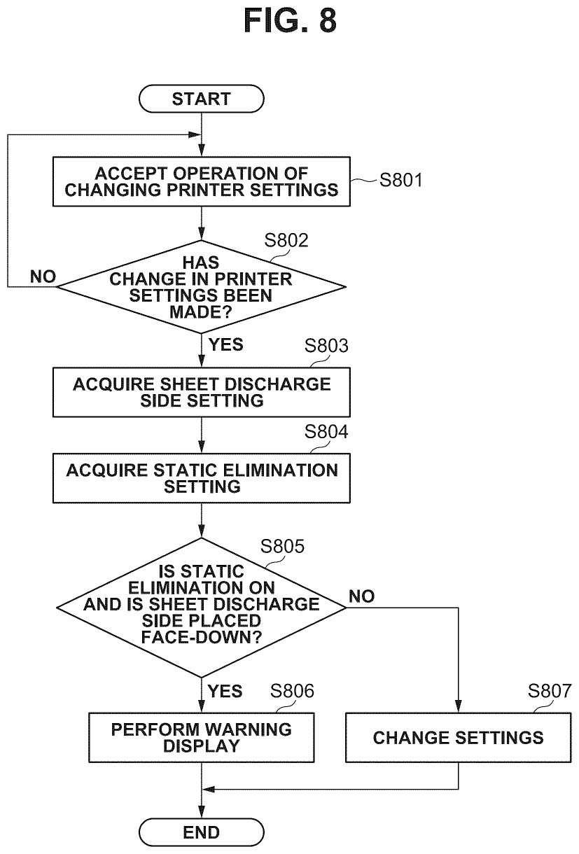

An example of printer setting processing to be used at the time of execution of print processing in the print system 1000 according to a first exemplary embodiment is described with reference to a flowchart in FIG. 8. Each step in the flowchart in FIG. 8 is implemented by the control unit 205 as a CPU loading a control program stored in the HDD 209 into the RAM 208 and executing the loaded control program.

In step S801, the control unit 205 accepts a change in printer settings.

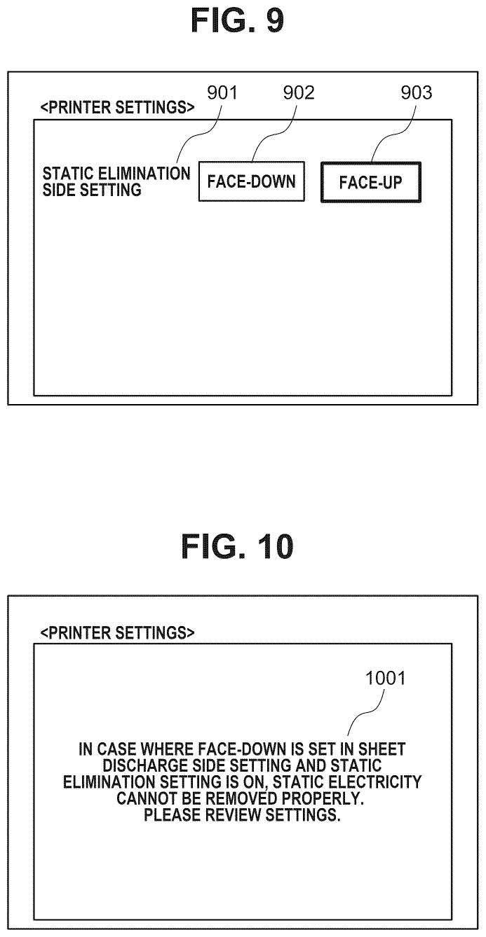

As the printer settings, the control unit 205 accepts a change in the static elimination setting illustrated in FIG. 6 or a change in the sheet discharge side setting illustrated in FIG. 9.

FIG. 9 illustrates an example of a setting screen for the sheet discharge side setting. Similarly to the static elimination setting in FIG. 6, the setting screen is displayed on the touch panel section 401 of the operation unit 204. By pressing a “face-down” button 902 or a “face-up” button 903, it is possible for the user to select whether to output the sheet with the print side facing upward (face-up) or downward (face-down).

In FIG. 9, the “face-up” button 903 is displayed to be surrounded with a thick line, which indicates a state in which the sheet discharge side setting has been accepted on the setting screen to output the sheet so that the print side is the upper side (face-up).

In step S802, the control unit 205 determines whether an operation of changing the printer settings has been accepted.

In a case where no change has been made (NO in step S802), the processing returns to step S801, and the control unit 205 continues to accept a change in the printer settings.

In a case where a change has been made (YES in step S802), the processing proceeds to step S803.

In step S803, the control unit 205 acquires a state of the sheet discharge side setting.

In step S804, the control unit 205 acquires a state of the static elimination setting.

In step S805, the control unit 205 checks whether the acquired static elimination setting is ON and whether the acquired sheet discharge side setting is set to face-down.

In a case where the static elimination setting is ON and the sheet discharge side setting is set to face-down (YES in step S805), the processing proceeds to step S806.

In step S806, the control unit 205 causes a warning display 1001 as illustrated in FIG. 10 to be displayed to the user and ends the present processing without changing the printer settings.

In a case where the static elimination setting is OFF or the sheet discharge side setting is not set to face-down (NO in step S805), the processing proceeds to step S807. In step S807, the control unit 205 stores the change in the printer settings accepted in step S801 and ends the present processing.

According to the flow in FIG. 8, it is possible to notify the user that static elimination does not work with the current printer settings. With this processing, it is possible to prevent deterioration in the quality of a print result due to deterioration in static elimination caused by the sheet discharge side setting set to face-down.

In the present exemplary embodiment, a restriction is placed on the printer settings when the static elimination setting is ON and the sheet discharge side setting is set to face-down, but another mode may be employed. For example, the present disclosure may employ a mode of, in a case where a static elimination roller 322 in the static elimination apparatus 200-3a has opposite polarity, issuing a warning against a combination of the static elimination setting being ON and the sheet discharge side setting being set to face-up and restricting the printer settings.

In the present exemplary embodiment, the example of selecting face-up or face-down as the sheet discharge side setting has been described above. Additionally, a warning may be issued against a combination of the static elimination setting being ON and a setting to switch whether to place the print side face-down or face-up as a result of printer settings regarding stapling, punching, folding, saddle stitch bookbinding, bookbinding, or the like in the finisher apparatus 200-3b.

While the warning is issued in a phase in which the printer settings are made in the first exemplary embodiment, a second exemplary embodiment is directed to issuance of a warning in a phase in which a print job is executed to enable proper static elimination.

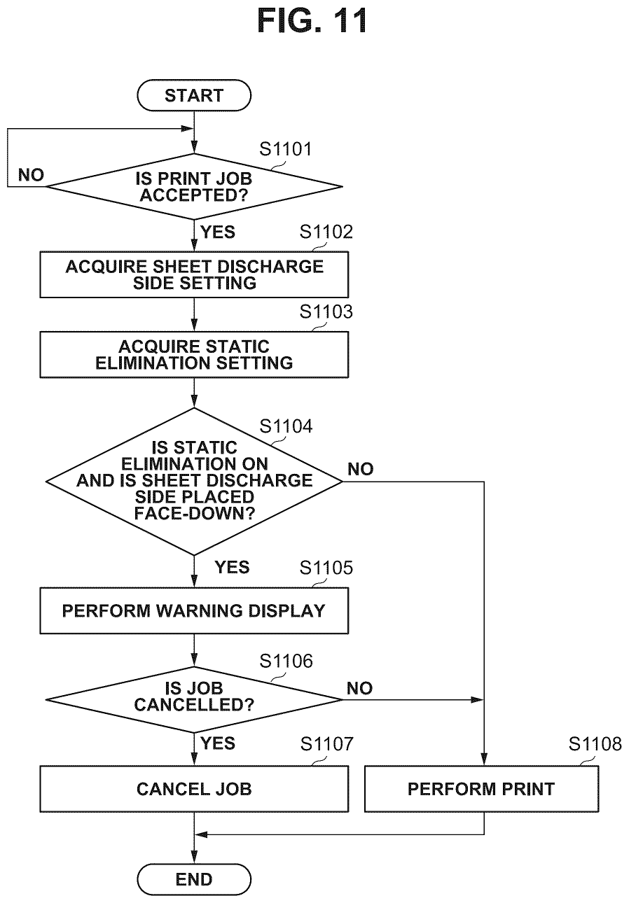

The processing for executing a print job in the second exemplary embodiment will be described with reference to FIG. 11.

FIG. 11 illustrates the processing for executing a print job in the print system 1000 from acceptance of the print job until execution of the printing. Each step of the flowchart in FIG. 11 is implemented by the control unit 205 as a CPU loading a control program stored in the HDD 209 into the RAM 208 and executing the loaded control program.

### (Print Job Execution Processing)

In step S1101, the control unit 205 stands by for acceptance of a print job.

In a case where the control unit 205 accepts the print job (YES in step S1101), the processing proceeds to step S1102. Otherwise (NO in step S1101), the processing returns to step S1101.

In step S1102, the control unit 205 acquires the sheet discharge side setting.

The sheet discharge side setting can be made from the printer setting screen as illustrated in FIG. 9 similarly to the first exemplary embodiment.

In step S1103, the control unit 205 acquires the static elimination setting.

The static elimination setting can be made from the printer setting screen as illustrated in FIG. 6 similarly to the first exemplary embodiment.

In step S1104, the control unit 205 determines whether the acquired static elimination setting is ON and whether the acquired sheet discharge side setting is set to face-down. In a case where the static elimination setting is ON and the sheet discharge side setting is not set to face-down (NO in step S1104), the processing proceeds to step S1108.

In step S1108, the control unit 205 processes the accepted print job, executes printing, and ends the present processing.

In a case where the static elimination setting is ON and the sheet discharge side setting is set to face-down (YES in step S1104), the processing proceeds to step S1105.

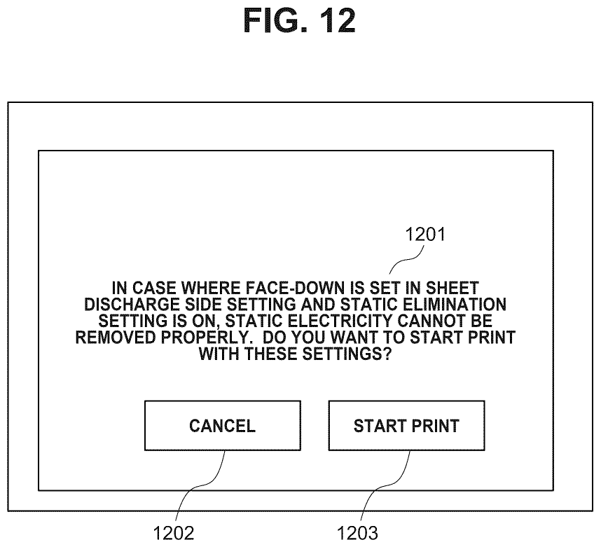

In step S1105, the control unit 205 displays a warning screen 1201 as illustrated in FIG. 12.

Warning display 1201 as illustrated in FIG. 12 is an example of a display of a warning message to the user indicating that static elimination is not performed properly when the static elimination setting is ON and the sheet discharge side setting is set to face-down. A “CANCEL” button 1202 is a button for accepting an operation of cancelling the job, and a “START PRINT” button 1203 is a button for continuing execution of the print job. The control unit 205 displays the warning screen illustrated in FIG. 12 and stands by until either the “CANCEL” button 1202 or the “START PRINT” button 1203 is pressed.

In step S1106, the control unit 205 checks whether a pressed button is the “CANCEL” button 1202. In a case where the “CANCEL” button 1202 is pressed (YES in step S1106), the processing proceeds to step S1107.

In step S1107, the control unit 205 cancels the print job and ends the present processing without performing printing. In a case where the “START PRINT” button 1203, instead of the “CANCEL” button 1202, is pressed (NO in step S1106), the processing proceeds to step S1108. In step S1108, the control unit 205 performs printing of the accepted print job and ends the present processing.

According to the flow in FIG. 11, it is possible to notify the user that printing is to be performed with the print settings in which static elimination does not work and thereby prevent unexpected deterioration in quality of a print product.

In the second exemplary embodiment, a warning is issued against the print job with the printer settings that combine the static elimination setting being ON and the sheet discharge side setting being set to face-down. However, a warning may be issued against a combination of, in a case where the static elimination roller 322 in the static elimination apparatus 200-3a has opposite polarity, the static elimination setting being ON and the sheet discharge side setting being set to face-up.

In the second exemplary embodiment, the example of selecting face-up or face-down as the sheet discharge side setting has been described above. Alternatively, a warning may be issued against a combination of the static elimination setting being ON and a setting to switch whether to place the print side face-down or face-up as a result of printer settings regarding stapling, punching, folding, saddle stitch bookbinding, bookbinding, or the like in the finisher apparatus 200-3b.

There is a case where the finisher apparatus 200-3b on the downstream side of the static elimination apparatus 200-3a includes a sheet inversion mechanism. In the following third exemplary embodiment, a description will be given of a case of switching processing depending on whether the sheet inversion mechanism is included.

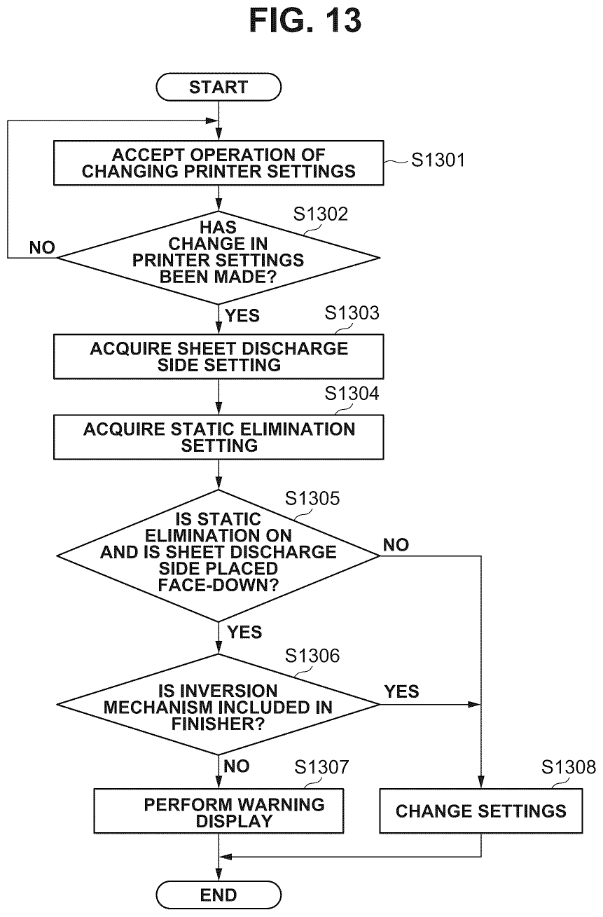

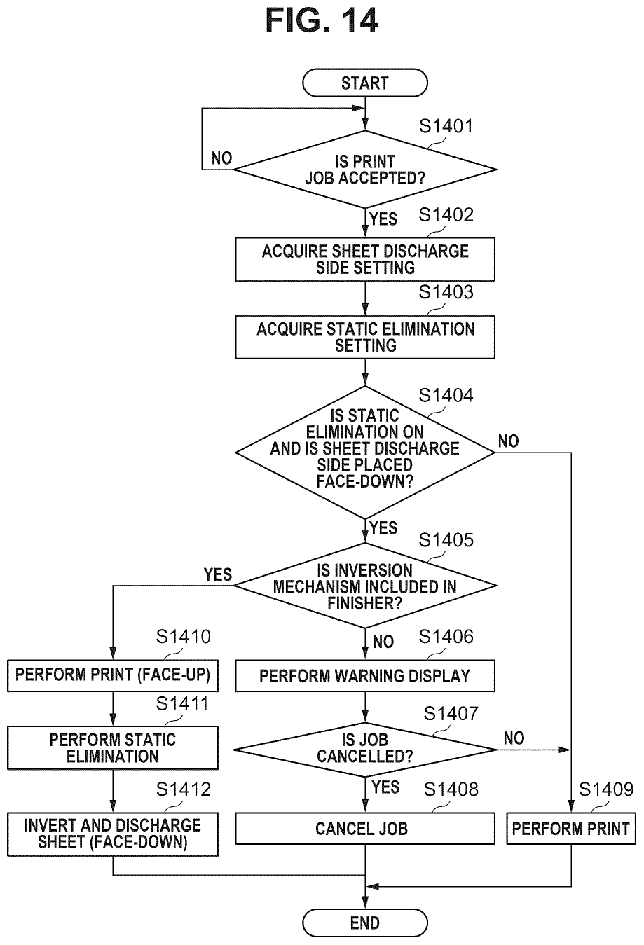

Printer setting processing and processing of executing a print job in the third exemplary embodiment will be described with reference to FIGS. 13 and 14.

### [Printer Setting Processing]

FIG. 13 is a flowchart illustrating printer setting processing to be used at the time of execution of print processing in the print system 1000. Each step in the flowchart in FIG. 13 is implemented by the control unit 205 as a CPU loading a control program stored in the HDD 209 into the RAM 208 and executing the loaded control program.

Because steps S1301 to S1305 are similar to steps S801 to S805 in FIG. 8 in the first exemplary embodiment, a description of steps S1301 to S1305 is omitted.

In step S1306, the control unit 205 checks whether the sheet inversion mechanism is included in the finisher apparatus 200-3b.

The finisher apparatus 200-3b includes a sheet discharge inversion path 350 as the sheet inversion mechanism and is capable of inverting the upper side and the lower side as the print side of the sheet and discharging the sheet to the sheet discharge destination Z.

In a case where the control unit 205 determines that the sheet inversion mechanism is included (YES in step S1306), the processing proceeds to step S1308.

In step S1308, the control unit 205 changes the printer settings so that the static elimination setting is ON and the sheet discharge side setting is face-down and ends the present processing.

In a case where the control unit 205 determines that the sheet inversion mechanism is not included (NO in step S1306), the processing proceeds to step S1307.

In step S1307, similar to the flow in FIG. 8, the control unit 205 causes a warning display as illustrated in FIG. 10 to be displayed to the user and ends the present processing without changing the settings.

In the third exemplary embodiment, unlike the first exemplary embodiment, in a case where the sheet inversion mechanism for switching whether to place the print side of the sheet face-up or face-down after static elimination is included in the finisher apparatus 200-3a on the downstream side, it is possible to permit settings that combine the static elimination setting being ON and the sheet discharge side setting being set to face-down.

### [Print Job Execution Processing]

FIG. 14 is a flowchart illustrating processing in the print system 1000 from acceptance of a print job until execution of the printing. Each step in the flowchart in FIG. 14 is implemented by the control unit 205 as a CPU loading a control program stored in the HDD 209 into the RAM 208 and executing the loaded control program.

Because steps S1401 to S1404 are similar to steps S1101 to S1104 in FIG. 11 in the second exemplary embodiment, a description of steps S1401 to S1404 is omitted.

In step S1405, the control unit 205 checks whether the sheet inversion mechanism is included in the finisher apparatus 200-3b.

In step S1405, similarly to step S1306 in FIG. 13, the control unit 205 determines whether there is the sheet discharge inversion path 350 as the sheet inversion mechanism.

In a case where the control unit 205 determines that there is no sheet inversion mechanism (NO in step S1405), the processing proceeds to step S1406.

In step S1406, similar to the flow in FIG. 11, the control unit 205 causes a warning display as illustrated in FIG. 12 to be displayed to the user.

Because steps S1407 to S1409 are similar to steps S1106 to S1108 in FIG. 11, a description of steps S1407 to S1409 is omitted.

In a case where the control unit 205 determines that the sheet inversion mechanism is included (YES in step S1405), the processing proceeds to step S1410. In step S1410, the control unit 205 performs printing with the sheet face-up. That is, even if the sheet discharge side setting is set to face-down, the sheet is not inverted on the sheet inversion path 720 and is conveyed to the static elimination apparatus 200-3a with the print side remaining face-up.

In step S1411, the control unit 205 performs static elimination on the sheet that is passing the static elimination roller 322 face-up in the static elimination apparatus 200-3a.

In step S1412, before discharging the sheet to the sheet discharge destination Z, the control unit 205 inverts the sheet on a sheet inversion path 350 so that the print side is placed face-down and then discharges the sheet.

According to the above-mentioned third exemplary embodiment, even in a case where the sheet discharge side setting is set to face-down, the static elimination apparatus 200-3a is capable of properly performing static elimination with the print side being placed face-up, thereafter inverting the sheet before discharging, and then discharging the sheet. As a result, it is possible to output the sheet face-down as set in the sheet discharge side setting.

In the third exemplary embodiment, with respect to the print job with the print settings that combine the static elimination setting being ON and the sheet discharge side setting being set to face-down, static elimination is performed, and thereafter the sheet is inverted so that the print side is placed face-down in the sheet inversion path mechanism in the finisher apparatus 200-3b and discharged. Alternatively, the present disclosure may employ a mode of, in a case where the static elimination apparatus 200-3a performs static elimination in opposite polarity, performing static elimination on a sheet whose print side is placed face-down with the printer settings that combine the static elimination setting being ON and the sheet discharge side setting being set to face-up, inverting the sheet to place the print side face-up on the sheet inversion path, and discharging the sheet.

In the third exemplary embodiment, the example of selecting face-up or face-down as the sheet discharge side setting has been described above. Alternatively, inverting and discharging of the sheet may be performed with respect to a combination of the static elimination setting being ON and a setting to switch whether to place the print side face-down or face-up as a result of printer settings regarding stapling, punching, folding, saddle stitch bookbinding, bookbinding, or the like in the finisher apparatus 200-3b.

In the present exemplary embodiment, the example has been given in which the print apparatus 100 performs printing on the upper side of a sheet and the static elimination apparatus 200-3a performs static elimination from the upper side of the sheet with the static elimination roller 322, but it is sufficient if the print side and the static elimination roller 322 come in contact with each other. For example, in a case where the print side is the lower side, the static elimination apparatus 200-3a is only required to perform static elimination from the lower side with the static elimination roller 322. Static elimination rollers to which voltages are applied are arranged in an up-and-down direction and a method of applying voltages to these static elimination rollers may be employed as necessary.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-108790, filed Jul. 5, 2024, the entirety of which is incorporated herein by reference.

What is claimed is:

1. A print system comprising:
a print apparatus configured to print an image on a sheet;
a static electricity elimination apparatus configured to perform static electricity elimination processing from a direction above the sheet;
at least one memory storing a program; and
at least one processor that, by execution of the stored program, is configured to operate as:
a first acceptance unit configured to accept a first setting regarding whether to perform the static electricity elimination processing on the sheet;
a second acceptance unit configured to accept a second setting regarding whether to place the sheet with its print side face-up or face-down when the sheet is discharged from the static electricity elimination apparatus; and
a notification unit configured to output a predetermined notification when the first acceptance unit has accepted a first setting to perform the static electricity elimination processing on the sheet and the second acceptance unit has accepted a second setting to place the sheet with its print side face-down.

2. The print system according to claim 1, wherein the predetermined notification is a notification prompting the user to change the second setting from placing the sheet with its print side face-down to placing the sheet with its print side face-up.

3. The print system according to claim 1, wherein the notification unit is further configured to display on a display unit a screen that includes the predetermined notification, a first object for receiving an operation input by a user to start a print process, and a second object for receiving an operation input by the user to cancel a print process.

4. The print system according to claim 1, wherein the notification unit is configured not to output the predetermined notification when the first acceptance unit has accepted a first setting to perform the static electricity elimination processing on the sheet, the second acceptance unit has accepted a second setting to place the sheet with its print side face-down, and a sheet inversion mechanism is included on a downstream side of the static electricity elimination apparatus.

5. The print system according to claim 4, wherein the at least one processor, by execution of the stored program, is further configured to operate as: a control unit configured to perform control to cause the sheet inversion mechanism to invert the sheet on which the image has been printed by the print apparatus when the first acceptance unit has accepted the first setting to perform the static electricity elimination processing on the sheet, the second acceptance unit has accepted the second setting to place the sheet with its print side face-down, and the sheet inversion mechanism is included on the downstream side of the static electricity elimination apparatus.

6. The print system according to claim 5,
wherein the notification unit is configured to output the predetermined notification when the first acceptance unit has accepted the first setting to perform the static electricity elimination processing on the sheet, the second acceptance unit has accepted the second setting to place the sheet with its print side face-down, and the sheet inversion mechanism is not included on the downstream side of the static electricity elimination apparatus, and
wherein the notification unit is further configured to display on a display unit a screen that includes the predetermined notification, a first object for receiving an operation input by a user to start a print process, and a second object for receiving an operation input by the user to cancel a print process.

7. A method of controlling a print system that includes a print apparatus configured to print an image on a sheet and a static electricity elimination apparatus configured to perform static electricity elimination processing from a direction above the sheet, the method comprising the steps of:
accepting, via a user interface, a first setting regarding whether to perform the static electricity elimination processing on the sheet;
accepting, via the user interface, a second setting regarding whether to place the sheet with its print side face-up or face-down when the sheet is discharged from the static electricity elimination apparatus; and
outputting a predetermined notification when a first setting to perform the static electricity elimination processing on the sheet has been accepted and a second setting to place the sheet with its print side face-down has been accepted.

8. A non-transitory computer-readable storage medium that stores a program for causing a computer to execute a method of controlling a print system that includes a print apparatus configured to print an image on a sheet and a static electricity elimination apparatus configured to perform static electricity elimination processing from a direction above the sheet, the method comprising the steps of:
accepting a first setting regarding whether to perform the static electricity elimination processing on the sheet;
accepting a second setting regarding whether to place the sheet with its print side face-up or face-down when the sheet is discharged from the static electricity elimination apparatus; and
outputting a predetermined notification when a first setting to perform the static electricity elimination processing on the sheet has been accepted and a second setting to place the sheet with its print side face-down has been accepted.
